(19) United States
(12) Patent Application Publication
(10) Pub. No.: US 2022/0036492 A1
(43) Pub. Date: Feb. 3, 2022

(54) GOODS-HANDLING METHOD AND GOODS-HANDLING SYSTEM

(71) Applicant: HKC CORPORATION LIMITED, Shenzhen (CN)

(72) Inventors: Posung PAN, Shenzhen (CN); Haijiang YUAN, Shenzhen (CN)

(21) Appl. No.: 17/383,388

(22) Filed: Jul. 22, 2021

(30) Foreign Application Priority Data
Jul. 29, 2020 (CN) 202010742938.6

(51) Int. Cl. G06Q 50/28; G07C 3/00; G06Q 10/06; G05B 19/418; B65G 49/06

(52) U.S. Cl. CPC G06Q 50/28; G07C 3/005; G06Q 50/04; G05B 19/4189; B65G 49/06; G06Q 10/06315

(57) ABSTRACT

The present application discloses a goods-handling method and a goods-handling system, where the goods-handling method includes steps of: obtaining working state information and handling instructions of a plurality of machines; executing the handling instructions to handle goods according to the working state information; where the working state information includes capacity information of the machines.

The present application claims priority to Chinese Patent Application No. 202010742938.6, filed Jul. 29, 2020, which is hereby incorporated by reference herein as if set forth in its entirety.

### TECHNICAL FIELD

The present application relates to the technical field of goods handling, particularly to a goods-handling method and a goods-handling system.

### BACKGROUND

The statements herein merely provide background information related to the present application and do not necessarily constitute the conventional art.

Generally, it is required to handle goods between warehouses and machines. There are multiple types of machines with relatively low capacities and high capacities, and there are multiple types of machines on a production line, i.e., a machine with a high capacity supplies a machine with a low capacity and a machine with a low capacity supplies a machine with a high capacity. Multiple handling instructions correspond to a plurality of machines, there is usually a limited number of handlers, and the exemplary goods-handling method is that the handlers handle the goods only according to handling instructions generation time, which means that the corresponding handling instructions with earlier generation time are preferentially executed.

In the exemplary goods handling method, machines with low capacities cannot be supplied in time, so that subsequent machines are not supplied enough, leading to machine idling.

### SUMMARY

The purpose of the present application is to provide a goods-handling method and a goods-handling system to avoid machine idling.

In order to achieve the above purpose, the present application provides a goods-handling method including steps of:

obtaining working state information and handling instructions of a plurality of machines; and

executing the handling instructions to handle goods according to the working state information;

where the working state information includes capacity information of the machines.

The present application also provides a goods-handling method including steps of:

obtaining working state information and handling instructions of a plurality of machines; and

executing the handling instructions to handle goods according to the working state information;

where the working state information includes capacity information, remaining processing time information, handling instruction generation time information and handling instruction type information, where the handling instruction type includes a first handling instruction and a second handling instruction;

the step of executing the handling instructions to handle goods according to the working state information includes:

determining whether the capacity information of the plurality of machines is the identical, if not, preferentially executing a handling instruction corresponding to a machine with a low capacity; if yes, continuously determining whether the handling instruction type information of the plurality of machines is the identical;

determining whether the handling instruction type information of the plurality of machines is the identical, if not, preferentially executing the first handling instruction; if yes, continuously determining whether the remaining processing time information of the plurality of machines is the identical;

determining whether the remaining processing time information of the plurality of machines is the identical, if not, preferentially executing a handling instruction corresponding to a machine with remaining processing time less than or equal to preset time; if yes, continuously determining sequence of the handling instruction generation time of the plurality of machines; and

determining the sequence of the handling instruction generation time of the plurality of machines, and preferentially executing a handling instruction corresponding to a machine with earlier handling instruction generation time;

where the step of executing the handling instructions to handle goods according to the working state information further includes:

determining whether the handling instructions corresponding to the plurality of machines are executed within preset time, if yes, continuing to performing, and if not, preferentially executing the handling instructions corresponding to the corresponding machines within next preset time.

The present application also provides a handling system, which includes a management system and a logistics system, where the management system is configured to obtain the working state information of a plurality of machines and generate corresponding handling instructions according to the working state information of the machines; the logistics system is in signal connection with the management system and is configured to execute the handling instruction according to the working state information; where the logistics system includes a warehousing system and a handler, the warehousing system is in signal connection with the management system, the warehousing system controls the handler to execute the handling instruction, and the working state information includes capacity information of the machines.

Compared with the exemplary technology of handling goods only according to the generation time of the handling instruction, in present application, the goods-handling method takes the working state information of the machine as reference to arrange the corresponding handling instruction; the working state information of the machine includes productivity information, and the machine is enabled to execute a handling instruction by considering the productivity information of the machine, so that the quantity of goods to be processed provided for the machine is sufficient, and the machine idling due to the fact that the productivity information of the machine and the corresponding handling instruction are not coordinated is avoided; for example, the situation that the handling instruction is executed only according to the generation time of the handling instruction, and the generation time of the handling instruction corresponding to the machine with a low capacity is late, which causes the idling of the subsequent machine with a low capacity, especially the subsequent machine with high capacity, can be avoided, thereby improving the production efficiency and avoiding the waste of capacity.

### BRIEF DESCRIPTION OF DRAWINGS

The accompanying drawings, which are included to provide a further understanding of embodiments of the present application and constitute a part of the specification, illustrate embodiments of the application and, together with the text description, explain the principles of the application. Obviously, the drawings in the following description are merely some embodiments of the present application, and those skilled in the art can obtain other drawings according to the drawings without any inventive labor. In the drawings:

FIG. 1 is a schematic view of a handling system according to an embodiment of the present application;

FIG. 2 is a flow schematic view of a handling method according to an embodiment of the present application;

FIG. 3 is a schematic view of a display panel's production line;

FIG. 4 is a flow schematic view of a handling method based on capacity information only according to an embodiment of the present application;

FIG. 5 is a flow schematic view of a handling method based on remaining processing time information and capacity information according to an embodiment of the present application;

FIG. 6 is a flow schematic view of another handling method based on remaining processing time information and capacity information according to an embodiment of the present application;

FIG. 7 is a flow schematic view of a handling method based on the handling instruction type according to an embodiment of the present application;

FIG. 8 is a schematic view of a shed arrangement according to an embodiment of the present application;

FIG. 9 is a flow schematic view of a handling method based on remaining processing time information and handling instruction type according to an embodiment of the present application;

FIG. 10 is a flow schematic view of a handling method based on capacity information and handling instruction type according to an embodiment of the present application;

FIG. 11 is a flow schematic view of a handling method based on capacity information, remaining processing time information, handling instruction type, and handling instruction production time according to an embodiment of the present application;

FIG. 12 is a flow schematic view of a handling method based on preset time for executing a handling instruction according to an embodiment of the present application; and

FIG. 13 is a flow schematic view of a specific handling method according to an embodiment of the present application.

### DETAILED DESCRIPTION OF EMBODIMENTS

The specific structural and functional details disclosed herein are merely representative and are illustrative of the exemplary embodiments of the present application. However, the present application may be embodied in many optional forms and should not be construed as being limited only to the embodiments set forth herein.

In the description of the present application, it should be understood that, the terms “center”, “horizontally”, “up”, “down”, “left”, “right”, “vertical”, “horizontal”, “top”, “bottom”, “inner”, “outer” and the like for indicating an orientation or positional relationship are based on the orientation or positional relationship shown in the accompanying drawings, and are intended solely to facilitate description and simplification of the description, and are not intended to indicate or imply that the device or element referred to must have a specific orientation, be constructed and operated in a specific orientation, and thus is not to be construed as limiting the present application. Further, the terms “first” and “second” are only for the purpose of description and cannot be construed to indicate relative importance or imply an indication of the number of technical features indicated. Therefore, a feature defined as “first” and “second” may explicitly or implicitly include one stage or more stages of the features. In the description of the present application, “multiple” means two or more unless otherwise noted. In addition, the term “including” and any variations thereof are intended to cover non-exclusive inclusion.

In the description of the present application, it should be noted that, unless expressly specified and defined otherwise, the terms “mount”, “attach” and “connect” are to be understood broadly, for example, it can be a fixed connection, a detachable connection, or an integral connection; it can be an either mechanical connection or an electrical connection; it can be a direct connection or an indirect connection through an intermediate medium, and can be an internal connection between two-stage elements. For those skilled in the art, the specific meaning of the above terms in this application can be understood according to the specific circumstances.

The terms used herein are merely intended to describe specific embodiments and are not intended to limit the exemplary embodiments. Unless clearly indicated by the context otherwise, the singular forms “a” or “an” are intended to include the plural. It should also be understood that the terms “include” and/or “comprise” as used herein specify the presence of the features, integers, steps, operations, units and/or components set forth without excluding the presence or addition of one or more other features, integers, steps, operations, units, components and/or combinations thereof.

The present application will now be described by reference to the accompanying drawings and embodiments.

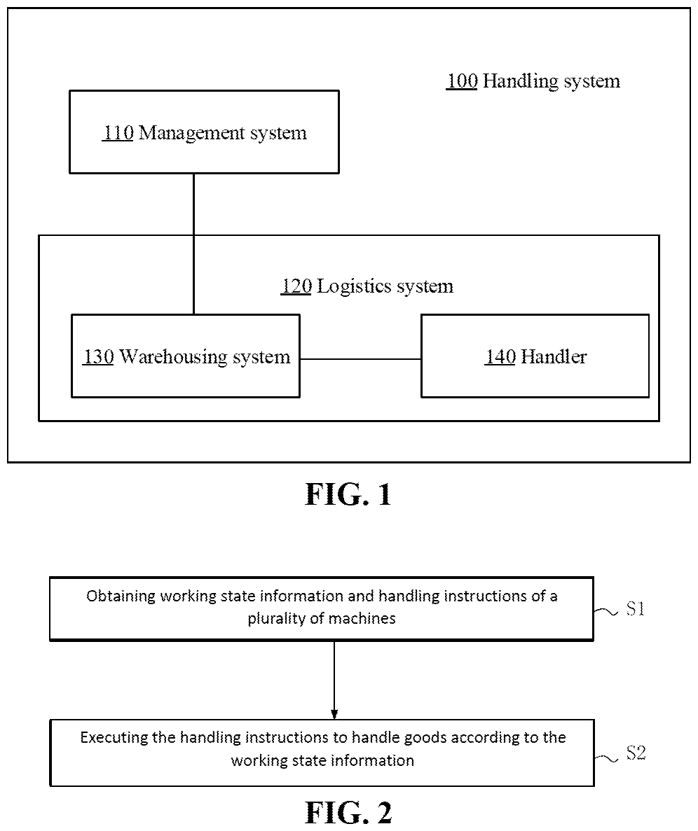

As shown in FIG. 1, an embodiment of the present application discloses a handling system 100, where the handling system 100 uses a goods-handling method, the handling system 100 includes a management system 110 and a logistics system 120, where the management system is configured to obtain the working state information of a plurality of machines and generate corresponding handling instructions according to the working state information of the machines; the logistics system is in signal connection with the management system and is configured to execute the handling instruction according to the working state information; where the logistics system includes a warehousing system 130 and a handler 140, the warehousing system is in signal connection with the management system, the warehousing system controls the handler to execute the handling instruction, and the working state information includes capacity information of the machines.

As shown in FIG. 2, the goods-handling method includes steps of:

S1: obtaining working state information and handling instructions of a plurality of machines; and

S2: executing the handling instructions to handle goods according to the working state information;

the working state information includes capacity information of the machines. Compared with the exemplary technology of handling goods only according to the generation time of the handling instruction, in present application, the goods-handling method takes the working state information of the machine as reference to arrange the corresponding handling instruction; the working state information of the machine includes productivity information, and the machine is enabled to execute a handling instruction by considering the productivity information of the machine, so that the quantity of goods to be processed provided for the machine is sufficient, and the machine idling due to the fact that the productivity information of the machine and the corresponding handling instruction are not coordinated is avoided; for example, the situation that the handling instruction is executed only according to the generation time of the handling instruction, and the generation time of the handling instruction corresponding to the machine with a low capacity is late, which causes the idling of the subsequent machine with a low capacity, especially the subsequent machine with high capacity, can be avoided, thereby improving the production efficiency and avoiding the waste of capacity.

The goods generally refer to a glass substrate, a display panel, and a display module in the production process of the display device, or a cassette loaded with the glass substrate, the display panel, or the display module.

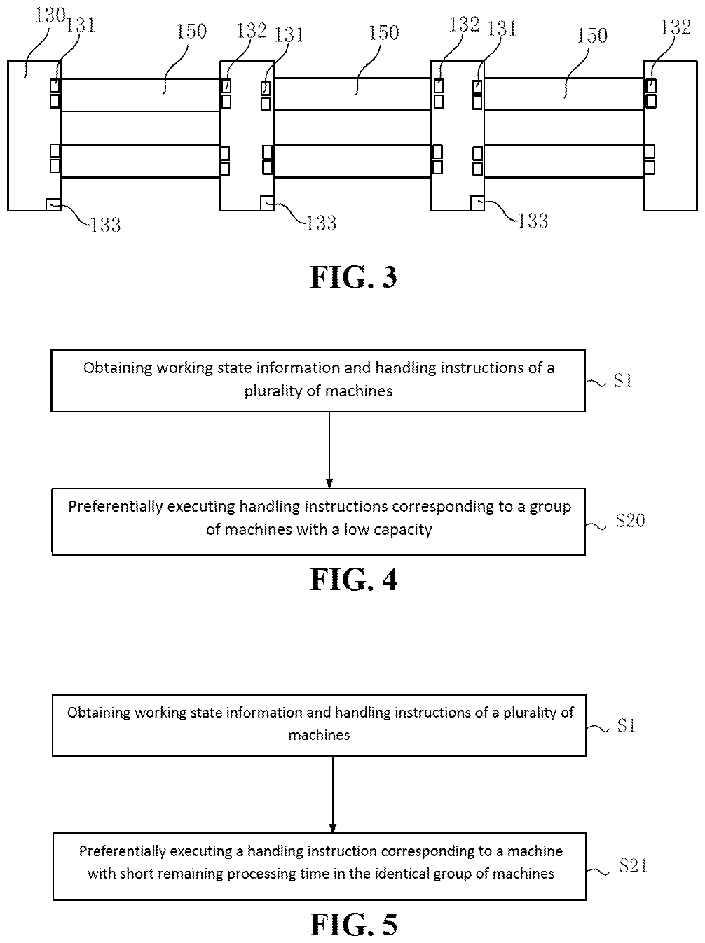

The handling system of present application can be adopted to display panel's production line. Specifically, as shown in FIG. 3, there are a plurality of different machines 150 in a production line, and a warehousing system 130 is disposed between different machines 10, and the machines are arranged according to a production flow and are sequentially polar attach machines, the lighting machine and the PCB binding machine from left to right; the automatic warehousing system is internally provided with a plurality of shelves, the shelves are provided with a plurality of sheds for containing cassettes, and one side of the machine is provided with a loading shed 131 for storing the cassettes loaded with materials to be processed; the other side of the machine is a unloading shed 132 for storing cassettes with processed materials; each corner of the automatic warehousing system 130 has a loading or unloading opening 133 of a machine. The handling system controls handling device to handle the cassettes between the shed.

Further, as shown in FIG. 4, the plurality of machines are divided into two groups according to capacity information, where the step S2 includes:

S20: preferentially executing handling instructions corresponding to a group of machines with a low capacity.

Considering that the generation time of the handling instruction corresponding to the machine with a low capacity is late, which causes the idling of the subsequent machine with a low capacity, especially the subsequent machine with high capacity, the present solution preferentially executes handling instructions corresponding to a group of machines with a low capacity, thereby improving the production efficiency and avoiding the waste of capacity.

Further, as shown in FIG. 5, the working state information includes remaining processing time information, and the plurality of machines are divided into two groups according to the capacity information, where the step S2 includes:

S21: preferentially executing a handling instruction corresponding to a machine with short remaining processing time in the identical group of machines.

A plurality of machines are divided into two groups according to capacity information, where a group of machines with lower capacity is bottleneck machines and a group of machines with lower capacity is non-bottleneck machines; the remaining processing time information of the machines is the ratio of the remaining amount of the goods to be processed to the capacity information of the machines, the capacity information of each machine is unchanged, and the remaining processing time can be calculated according to the detected remaining amount of the goods to be processed so as to generate the remaining processing time information; considering that whether the machine is a bottleneck machine or a non-bottleneck machine, the supply and demand requirement of each group of machines are met according to the urgent demand degree, and if the urgent demand is not met on time, the machine idling may occur, so the solution takes the remaining time processing information as a determination basis, and preferentially executes a handling instruction corresponding to a machine with short remaining processing time in each group of machines, so as to prevent the machine with short remaining processing time from idling.

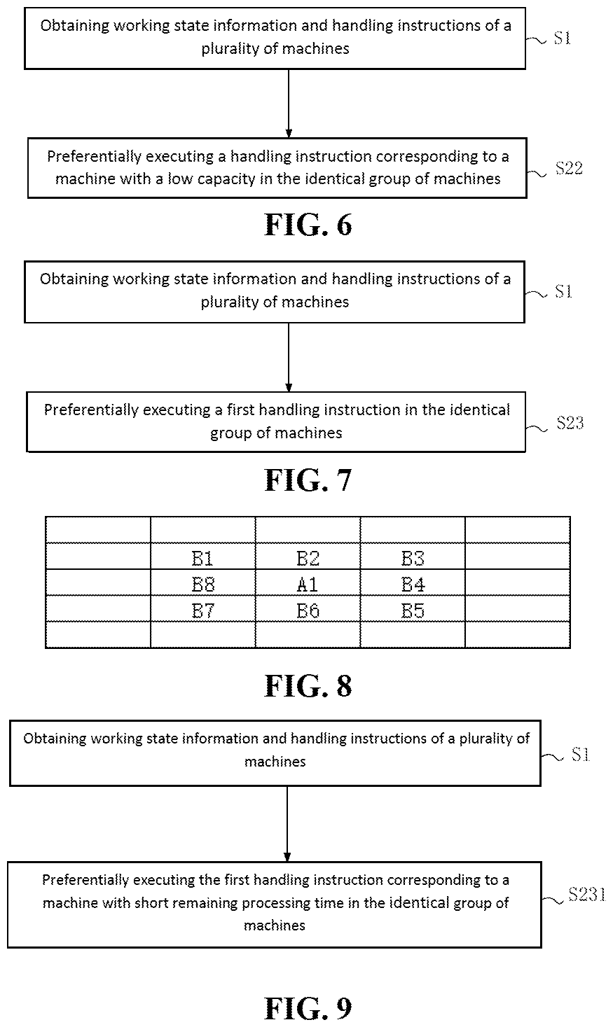

As shown in FIG. 6, the working state information includes remaining processing time information, and the plurality of machines are divided into two groups according to the remaining processing time information, where the step S2 includes:

S22: preferentially executing a handling instruction corresponding to a machine with short remaining processing time in the identical group of machines.

A plurality of machines are divided into two groups according to the remaining processing time information, that is, the machines with the remaining processing time greater than preset time are a group, and the machines with remaining processing time less than or equal to the preset time are a group, that is, the plurality of machines are divided according to the urgency of demand and supply; considering that a production line is usually composed of bottleneck machines and non-bottleneck machines as mentioned above, then there will be a situation where bottleneck machines supply non-bottleneck machines, that is, the supply of bottleneck machines is small, while the demand of the corresponding non-bottleneck machines is large, so the bottleneck machines need to be supplied on time, otherwise the corresponding non-bottleneck machines will be insufficiently supplied, thus leading to idling. Therefore, this solution takes production capacity information as a determination basis, and preferentially executes a handling instruction corresponding to a machine with a low capacity in each group of machines, so as to prevent the machine corresponding to a production line from idling.

The preset time can be one hour or other time, and can be set according to specific needs.

As shown in FIG. 7, the handling instruction includes a first handling instruction and a second handling instruction, the machines are divided into two groups according to the working state information, and the step S2 includes:

S23: preferentially executing the first handling instruction in the identical group of machines;

where the first handling instruction is a loading instruction for handling goods to machines, the second handling instruction is an unloading instruction for handling the goods away from the machine, the solution can be implemented in the field of display panel production, the first handling instruction is adopted to handle a cassette loaded with glass substrate to the machine so as to process the glass substrate, the second handling instruction is adopted to handle the cassette loaded with the used up glass substrate away from the machine so as to vacate the position for handling the cassette loaded with glass substrate to the machine; considering the idling of the machine is occurred due to the lack of goods, so the solution takes the handling instruction type as a determination basis, and preferentially executes the handling instruction for handling the cassette loaded with the glass substrate to the machine in each group of machines, and prevents the machine corresponding to a production line from idling.

If the position of a machine corresponding to the first handling instruction within a preset range has the corresponding second handling instruction, the corresponding second handling instruction is executed after the first handling instruction is executed. As shown in FIG. 8, each machine has a plurality of corresponding shed, and assuming that shed A1 is to execute a first handling instruction, and the shed B1-8 of the upper, lower, left, right and four diagonal positions of the shed A1 have corresponding second handling instructions to be executed, the sequence of the second handling instructions can be advanced, and the second handling instructions are executed directly after the first handling instructions are executed. Therefore, the first instruction and the second instruction close to the handling position are executed in a matched mode, and the handling efficiency can be improved.

Specifically, as shown in FIG. 9, in the present application, the solution of preferentially executing the handling instruction of the machine with short remaining processing time is combined with the solution of preferentially executing the first handling instruction, and when a plurality of machines are divided into two groups according to the capacity information, the step S23 includes:

S231: preferentially executing the first handling instruction corresponding to a machine with short remaining processing time in the identical group of machines.

Meanwhile, the remaining processing time and the handling instruction type are considered, so that the first handling instruction of the machine with short remaining time can be executed more quickly, and the situation that the idling of machine with short remaining time or the idling of subsequent machine of the machine with short remaining time due to insufficient goods supply are avoided.

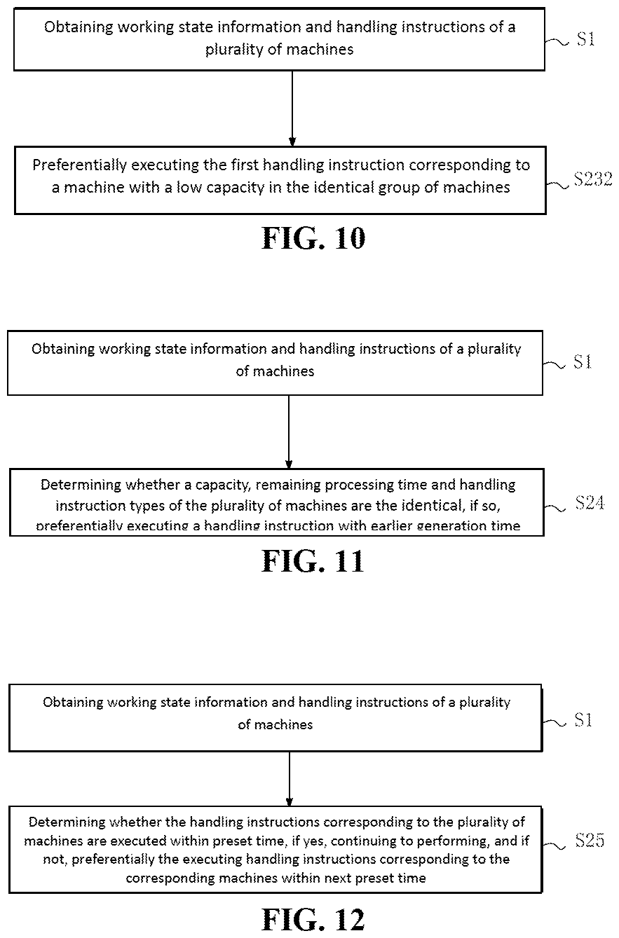

As shown in FIG. 10, in the present application, the solution of preferentially executing the handling instruction corresponding to the machine with a low capacity is combined with the solution of preferentially executing the first handling instruction, and when a plurality of machines are divided into two groups according to the short remaining processing time, the step S23 includes:

S232: preferentially executing the first handling instruction corresponding to a machine with a low capacity in the identical group of machines.

Meanwhile, the capacity and the handling instruction type are considered, so that the first handling instruction of the machine with a low capacity can be executed more quickly, and the situation that the idling of machine with a low capacity or the idling of subsequent machine of the machine with a low capacity due to insufficient goods supply are avoided.

Further, as shown in FIG. 11, the step S2 includes:

S24: determining whether the capacity information of the plurality of machines, the remaining processing time information and the handling instruction types are the identical, if yes, preferentially executing a handling instruction with earlier generation time.

Considering that the time of the handling instruction generated by the plurality of machines is generally accurate to seconds, the time of the handling instruction generated by the plurality of machines is generally different, and there are generally a plurality of machines with the identical capacity, a plurality of machines with identical remaining processing time, namely a plurality of machines with the identical remaining quantity of the goods to be processed, and a plurality of machines with identical handling instructions; there are a plurality of machines with identical capacity, identical remaining processing time and identical type of handling instructions. In order to facilitate the arrangement of the handling, when there are a plurality of machines with identical capacity, identical remaining processing time and identical type of handling instructions, the handling instruction with the earlier generation time is preferentially executed, so that the uniqueness of the execution of the handling instruction can be realized, the occurrence of handling instructions executed simultaneously is avoided, and the ordered execution of the handling is facilitated.

As shown in FIG. 12, the step S2 further includes:

S25: determining whether the handling instructions corresponding to the plurality of machines are executed within preset time, if yes, continuing to performing, and if not, preferentially executing the handling instructions corresponding to the corresponding machines within next preset time.

Specifically, the preset time is one hour. Considering that the handling instruction of the machine is executed according to a certain priority condition, then the handling instruction with a lower priority conditions may not be executed within one hour. Then as time passes, if the handling instruction with the lower priority condition has not been executed in the next hour, the corresponding machines may be out of loading and idling. Therefore, this solution determines whether the handling instructions of all machines have not been executed within one hour. If so, the handling instruction with the lower priority condition will be executed first in the next hour, which can prevent the corresponding machine and the subsequent machines of the corresponding production line from idling.

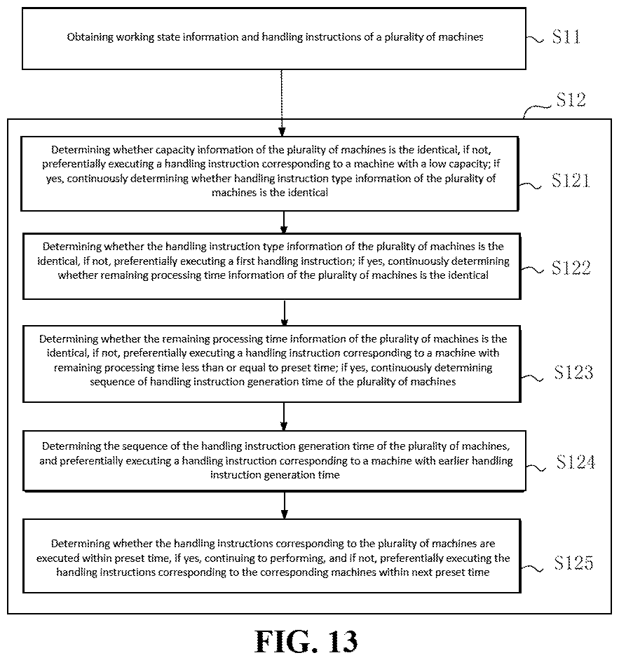

As shown in FIG. 13, an embodiment of the present application discloses a goods-handling method, including steps of:

S11: obtaining working state information and handling instructions of a plurality of machines: and

S12: executing the handling instructions to handle goods according to the working state information;

where the working state information includes capacity information, remaining processing time information, handling instruction generation time information and handling instruction type information, where the handling instruction type includes a first handling instruction and a second handling instruction:

the step of executing the handling instructions to handle goods according to the working state information includes:

preferentially executing a handling instruction corresponding to a machine with earlier handling instruction generation time.

The step S12 includes:

S121: determining whether the capacity information of the plurality of machines is the identical, if not, preferentially executing a handling instruction corresponding to a machine with a low capacity; if yes, continuously determining whether the handling instruction type information of the plurality of machines is the identical:

S122: determining whether the handling instruction type information of the plurality of machines is the identical, if not, preferentially executing the first handling instruction; if yes, continuously determining whether the remaining processing time information of the plurality of machines is the identical;

S123: determining whether the remaining processing time information of the plurality of machines is the identical, if not, preferentially executing a handling instruction corresponding to a machine with remaining processing time less than or equal to preset time; if yes, continuously determining sequence of the handling instruction generation time of the plurality of machines; and

S124: determining the sequence of the handling instruction generation time of the plurality of machines, and preferentially executing a handling instruction corresponding to a machine with earlier handling instruction generation time;

where the step of executing the handling instructions to handle goods according to the working state information further includes:

S125: determining whether the handling instructions corresponding to the plurality of machines are executed within preset time, if yes, continuing to performing, and if not, preferentially executing the handling instructions corresponding to the corresponding machines within next preset time.

The solution executes the handling instruction based on the priority sequence of the productivity information of the machine, instruction type information, the remaining processing time, the handling instruction generating time and whether the handling instruction is executed within the preset time or not; specifically, firstly, which machines are bottleneck machines with low capacities and the rest are non-bottleneck machines is determined, and a handling instruction of the bottleneck machine is preferentially executed when selecting bottleneck machine and non-bottleneck machine; which machines corresponding to first handling instructions (loading instructions) and which machines corresponding to second handling instructions (unloading instructions) are determined when a plurality of machines are bottleneck machines or non-bottleneck machines, and the loading instructions are preferentially executed when continuously selecting the loading instructions and the unloading instructions; under the condition that the types and the handling instructions of the plurality of machines are the identical, the remaining processing time of the plurality of machines is continuously determined, and a handling instruction with short remaining processing time of a machine is preferentially executed; under the condition that the types, the handling instructions and the remaining processing time of the plurality of machines are the identical, the handling instruction generation time of the plurality of machines is continuously determined, and a handling instruction with earlier generation time is preferentially executed; and then after executing preset time according to the priority condition sequence, whether the handling instructions corresponding to the plurality of machines are not executed in the preset time is determined, if yes, the unexecuted handling instructions in the next preset time is preferentially executed. In the solution of the present application, the working state information of the machines is determined in detail, and then the corresponding handling instructions are reasonably arranged and executed, so that each machine can be supplied, the idling of machine due to not enough supply is avoided, and the production efficiency is greatly improved.

The sequence of priority conditions may be other determination sequence, or may be other priority conditions added, and may be arranged according to specific conditions.

It should be noted that, the limitation of the steps involved in the present application, without affecting the implementation of the specific solution, is not determined to limit the sequence of steps, and the previous steps may be executed first, later, or even simultaneously. Any sequence shall be deemed to fall within the scope of the present application as long as the present application can be implemented.

The present application relates to a handling process of a glass substrate and a cassette thereof in a production process of a display panel, where the display panel can be a Twisted Nematic (TN) panel, a Vertical Alignment (VA) panel or a Multi-domain Vertical Alignment (MVA) panel, and the display panel can also be other type of panel applicable to the process.

The above content is a detailed description of the present application in conjunction with specific, optional embodiments, and it is not to be construed that specific embodiments of the present application are limited to these descriptions. For those of ordinary skill in the art to which this application belongs, a number of simple derivations or substitutions may be made without departing from the spirit of this application, all of which shall be deemed to fall within the scope of this application.

What is claimed is:

1. A goods-handling method, comprising steps of:
obtaining working state information and handling instructions of a plurality of machines; and
executing the handling instructions to handle goods according to the working state information;
wherein the working state information comprises capacity information of the machines.

2. The goods-handling method according to claim 1, wherein the plurality of machines are divided into two groups according to the capacity information, and the step of executing the handling instructions to handle goods according to the working state information comprises:
preferentially executing handling instructions corresponding to a group of machines with a low capacity.

3. The goods-handling method according to claim 1, wherein the working state information further comprises remaining processing time information, the plurality of machines are divided into two groups according to the capacity information, and the step of executing the handling instructions to handle goods according to the working state information comprises:
preferentially executing a handling instruction corresponding to a machine with short remaining processing time in the identical group of machines.

4. The goods-handling method according to claim 3, wherein the remaining processing time information of the machine is a ratio of the remaining amount of the goods to be processed to the capacity information of the machine.

5. The goods-handling method according to claim 1, wherein the working state information further comprises remaining processing time information, the plurality of machines are divided into two groups according to the capacity information, and the step of executing the handling instructions to handle goods according to the working state information comprises:
preferentially executing a handling instruction corresponding to a machine with a low capacity in the identical group of machines.

6. The goods-handling method according to claim 1, wherein the handling instruction comprises a first handling instruction and a second handling instruction, the plurality of machines are divided into two groups according to the working state information, and the step of executing the handling instructions to handle goods according to the working state information comprises:
preferentially executing the first handling instruction in the identical group of machines;
wherein the first handling instruction is an instruction for handling goods to the machine; the second handling instruction is an instruction for handling the goods away from the machine.

7. The goods-handling method according to claim 6, wherein the working state information comprises remaining processing time information, the plurality of machines are divided into two groups according to the capacity information, and the step of preferentially executing the first handling instruction in the identical group of machines comprises:
preferentially executing a first handling instruction corresponding to a machine with short remaining processing time in the identical group of machines.

8. The goods-handling method according to claim 6, wherein the working state information comprises remaining processing time information, the plurality of machines are divided into two groups according to the remaining processing time information, and the step of preferentially executing the first handling instruction in the identical group of machines comprises:
preferentially executing the first handling instruction corresponding to a machine with a low capacity in the identical group of machines.

9. The goods-handling method according to claim 6, wherein the first handling instruction is to handle a cassette loaded with a glass substrate to a machine, and the second handling instruction is to handle the cassette with the used up glass substrate away from the machine.

10. The goods-handling method according to claim 9, wherein the handling instruction for handling the cassette loaded with the glass substrate to the machine is preferentially executed in each group of machines.

11. The goods-handling method according to claim 1, wherein the working state information comprises remaining processing time information and generation time information of a handling instruction, the handling instruction comprises a plurality of first handling instructions and a plurality of second handling instructions, and the step of executing the handling instructions to handle goods according to the working state information comprises:
determining whether the capacity, the remaining processing time and the handling instruction types of the plurality of machines are the identical, if yes, preferentially executing a handling instruction with earlier generation time.

12. The goods-handling method according to claim 1, wherein the working state information comprises generation time information of a handling instruction, and the step of executing the handling instructions to handle goods according to the working state information comprises:
preferentially executing a handling instruction corresponding to a machine with earlier handling instruction generation time.

13. The goods-handling method according to claim 6, wherein if the position of a machine corresponding to the first handling instruction within a preset range has the corresponding second handling instruction, the corresponding second handling instruction is executed after the first handling instruction is executed.

14. The goods-handling method according to claim 1, wherein the goods comprises a glass substrate, a display panel, a display module, or a cassette loaded with the glass substrate, the display panel, or the display module.

15. A goods-handling method, comprising steps of:
obtaining working state information and handling instructions of a plurality of machines; and
executing the handling instructions to handle goods according to the working state information;
wherein the working state information comprises capacity information, remaining processing time information, handling instruction generation time information and handling instruction type information, wherein the handling instruction type comprises a first handling instruction and a second handling instruction;
the step of executing the handling instructions to handle goods according to the working state information comprises:
determining whether the capacity information of the plurality of machines is the identical, if not, preferentially executing a handling instruction corresponding to a machine with a low capacity; if yes, continuously determining whether the handling instruction type information of the plurality of machines is the identical;
determining whether the handling instruction type information of the plurality of machines is the identical, if not, preferentially executing the first handling instruction; if yes, continuously determining whether the remaining processing time information of the plurality of machines is the identical;
determining whether the remaining processing time information of the plurality of machines is the identical, if not, preferentially executing a handling instruction corresponding to a machine with remaining processing time less than or equal to preset time: if yes, continuously determining sequence of the handling instruction generation time of the plurality of machines; and
determining the sequence of the handling instruction generation time of the plurality of machines, and preferentially executing a handling instruction corresponding to a machine with earlier handling instruction generation time;
wherein the step of executing the handling instructions to handle goods according to the working state information further comprises:
determining whether the handling instructions corresponding to the plurality of machines are executed within preset time, if yes, continuing to performing, and if not, preferentially executing the handling instructions corresponding to the corresponding machines within next preset time.

16. The goods-handling method according to claim 15, wherein the remaining processing time information of the machine is a ratio of the remaining amount of the goods to be processed to the capacity information of the machine.

17. The goods-handling method according to claim 15, wherein if the position of a machine corresponding to the first handling instruction within a preset range has the corresponding second handling instruction, the corresponding second handling instruction is executed after the first handling instruction is executed.

18. A handling system, comprising:
a management system, configured to obtain working state information of a plurality of machines and generate corresponding handling instructions according to the working state information of the machines; and
a logistics system, configured to be in signal connection with the management system and configured to execute the handling instructions according to the working state information;
wherein the logistics system comprises a warehousing system and a handler, the warehousing system is in signal connection with the management system, the warehousing system controls the handler to execute the handling instructions, and the working state information comprises capacity information of the machines.
